(19) United States
(12) Patent Application Publication
(10) Pub. No.: US 2020/0372495 A1
(43) Pub. Date: Nov. 26, 2020

(54) AUTHENTICATING A USER FOR A TRANSACTION BASED ON DEVICE-BASED AUTHENTICATION DATA BY A PAYMENT NETWORK

(71) Applicant: MASTERCARD INTERNATIONAL INCORPORATED, Purchase, NY (US)

(72) Inventors: Rajat MAHESHWARI, Singapore (SG); Vijin VENUGOPALAN, Singapore (SG); Jonathan GROSSAR, Jersey City, NJ (US)

(21) Appl. No.: 16/740,773

(22) Filed: Jan. 13, 2020

Related U.S. Application Data
(60) Provisional application No. 62/850,479, filed on May 20, 2019.

(51) Int. Cl. G06Q 20/36; G06Q 20/38

(52) U.S. Cl. CPC G06Q 20/3674; G06Q 20/3678; G06Q 20/38215

(57) ABSTRACT

The disclosure herein describes authentication of a user based on device-based user authentication data for transactions associated with a payment account. A service receives a registration message including device-based user authentication data and a payment account identifier. Based on the device-based user authentication data matching an authentication data type of issuer-approved data types, the device-based user authentication data is linked with the payment account. An authentication request associated with a transaction from the payment account is received including device-based user authentication data of the user. The user is authenticated based on the device-based user authentication data of the authentication request matching the device-based user authentication data linked with the payment account, whereby authentication of the identity of the user for the transaction is delegated to the service by the issuer of the payment account based on the linking of the device-based user authentication data with the payment account.

### CROSS-REFERENCE TO RELATED APPLICATION

This application claims priority to U.S. Provisional Application No. 62/850,479, filed May, 20, 2019, the entirety of which is incorporated herein by reference.

### BACKGROUND

Authentication of a user's identity using local, device-based authentication information is popular for accessing mobile devices and for other functionality associated with such mobile devices. For instance, users can access their smartphones by providing a fingerprint or by allowing the devices to recognize their faces and/or eyes. Such authentication techniques provide security. However, authentication of a user during online credit-based transactions or other similar transactions may have more, and/or more difficult, requirements such that regulators and issuers have shown discomfort approving such device-based authentication for use during online transactions.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for authenticating an identity of a user based on device-based user authentication data for transactions associated with a payment account is described. A device authentication validation (DAV) service receives a registration message including device-based user authentication data associated with a computing device of the user and an account identifier associated with the payment account. Based on an authentication data type of the device-based user authentication data matching at least one authentication data type in a set of issuer-approved authentication data types associated with an issuer of the payment account, the device-based user authentication data is linked with the payment account in a data store of the DAV service. An authentication request associated with a transaction from the payment account is received that includes device-based user authentication data from the computing device of the user. The identity of the user is then authenticated based on the validation of the device-based user authentication data of the received authentication request and on the device-based user authentication data of the received authentication request matching the device-based user authentication data linked with the payment account in the data store of the DAV service, whereby authentication of the identity of the user for the transaction is delegated to the DAV service by the issuer of the payment account based on the linking of the device-based user authentication data with the payment account.

### BRIEF DESCRIPTION OF THE DRAWINGS

The present description will be better understood from the following detailed description read in light of the accompanying drawings, wherein:

FIG. 1 is a block diagram illustrating a system configured for enabling device-based authentication validation and authenticating transactions based thereon according to an embodiment;

FIG. 2 is a block diagram illustrating a user device configured for enabling device-based authentication via a wallet according to an embodiment;

FIG. 3 is a sequence diagram illustrating a computerized method for performing identification and verification (ID&V) of a user with respect to an issuer according to an embodiment;

FIG. 4 is a sequence diagram illustrating a computerized method for enrolling a user's account for use with a device-based authenticator according to an embodiment;

FIG. 5 is a sequence diagram illustrating a computerized method for registering a user's account and associated device-based authenticator with a device authentication validation (DAV) service according to an embodiment;

FIG. 6 is a sequence diagram that illustrates a computerized method for preparing a cryptographic proof from the device-based authentication data and for submitting the cryptographic proof to the payment network for authentication during a transaction according to an embodiment;

FIG. 7 is a flow chart that illustrates a computerized method for authenticating an identity of a user based on validation of device-based user authentication data and based on linking device-based user authentication data for transactions associated with a payment account according to an embodiment;

FIG. 8 is a diagram illustrating a graphical user interface (GUI) configured for authentication of an electronic transaction using device-based authentication from a user's point of view according to an embodiment; and

FIG. 9 illustrates a computing apparatus according to an embodiment as a functional block diagram.

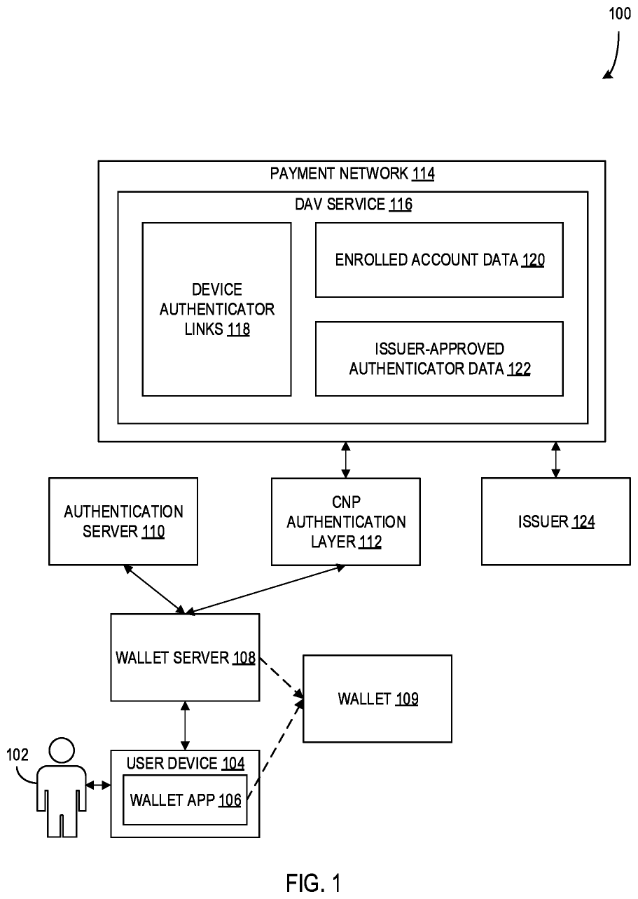

Corresponding reference characters indicate corresponding parts throughout the drawings. In FIGS. 1 to 9, the systems are illustrated as schematic drawings. The drawings may not be to scale.

### DETAILED DESCRIPTION

Aspects of the disclosure provide a computerized method and system for authenticating an identity of a user based on device-based user authentication data for transactions associated with a payment account. A device authentication validation (DAV) service receives a registration message including device-based user authentication data and an account identifier associated with the payment account. Based on the device-based user authentication data matching a set of issuer-approved authentication data types associated with an issuer of the payment account, the device-based user authentication data is linked with the payment account in the DAV service. Later, an authentication request associated with a transaction from the payment account is received that includes device-based user authentication data from the computing device of the user. During the authentication process of processing the transaction, the user is then authenticated based on the validation of the device-based user authentication data of the received authentication request and on the device-based user authentication data of the received authentication request matching the device-based user authentication data linked with the payment account in the DAV service. As a result, authentication of the user is delegated to the DAV service by the issuer of the payment account based on the linking of the device-based user authentication data with the payment account.

The disclosure addresses the challenges of securing digital payment scenarios and ensuring that only the legitimate cardholders are able to use card credentials for a transaction, through proper authentication of the consumer during the transaction. Further, the disclosure delivers a smooth, efficient user experience in online checkouts by minimizing friction that might typically be present during authentication. With this in mind, this disclosure describes the DAV service/program, which is configured to deliver consumer authentication with a smooth user experience, thereby decreasing transaction abandonments and fraud, while increasing transaction approval rates. The DAV program aligns with and/or makes use of industry standards for authentication operations, such as EUROPAY, MASTERCARD, and VISA THREE-DOMAIN SECURE (EMV 3DS) and FAST IDENTITY ONLINE (FIDO), in some examples, and is built on the authentication network of a payment network entity, such as the MASTERCARD authentication network. The disclosure operates in an unconventional way by enabling issuers to participate in the initial formation of links between device-based authenticators and payment accounts and to delegate further authentication processes to the DAV service based on those formed links. The disclosed DAV service operates with innovative authentication technologies such as device biometrics to provide at least the following benefits:
Consumers have the convenience of using authentication mechanisms enabled on their personal devices (mobile devices or PCs), to perform online transactions. Consumer authentication within the wallet application or merchant application interface is enabled.
Merchants have an opportunity to deliver a responsive checkout experience, and to keep control over the user experience, with an authentication embedded within their web page or application, which reduces the quantity of network communications necessary and the associated bandwidth usage to authenticate transactions, while also decreasing the time that end users spend waiting for the transaction to be completed.
Issuers have an opportunity to delegate their authentication to merchants or wallets for online checkouts, with MASTERCARD validating the authentication results provided from approved authentication solutions, such that bandwidth usage and other associated resource usage is reduced or eliminated with respect to the computing resources of the issuers.

FIG. 1 is a block diagram illustrating a system 100 configured for enabling device-based authentication validation and authenticating transactions based thereon according to an embodiment. System 100 is configured for authenticating the user 102 based on device-based authenticators of the user device 104 and linking the device-based authenticators to approval by the issuer 124, wherein the device authenticator links 118 are used by the payment network 114 to authenticate the user 102 during transactions without further authentication processing by the issuer 124.

The user device 104 of the user 102 includes hardware, firmware, and/or software configured to execute the wallet application or app 106 and to further enable the user 102 to initiate electronic payments and/or other similar transactions. The user device 104 is a computing device and may be at least one of a personal computer, a laptop computer, a tablet, a mobile phone, or other type of mobile computing device. The user 102 uses the user device 104 and the user device 104 is owned by and/or otherwise associated with the user 102.

The wallet app 106 includes software configured to initiate and otherwise handle electronic payments or transactions as described herein. Further, the wallet server 108 includes hardware, firmware, and/or software configured to enable such transactions through interactions with the wallet app 106 on the user device 104, the authentication server 110, the “Card Not Present” (CNP) authentication layer 112, and/or other entities or components as described herein. In some examples, the wallet app 106 and wallet server 108 are closely related and provided by the same entity (e.g., a merchant, payment service provider (PSP), or other wallet provider entity) for use by the user 102 during transactions. It should be understood that the wallet app 106 may act as a client to the wallet server 108 and that, together, the app 106 and server 108 may be referred to as an electronic wallet, e-wallet, or wallet 109 throughout this disclosure. Further, it should be understood that the wallet 109 may include more, fewer, and/or different entities or components configured to perform the authentication operations described herein without departing from the description herein.

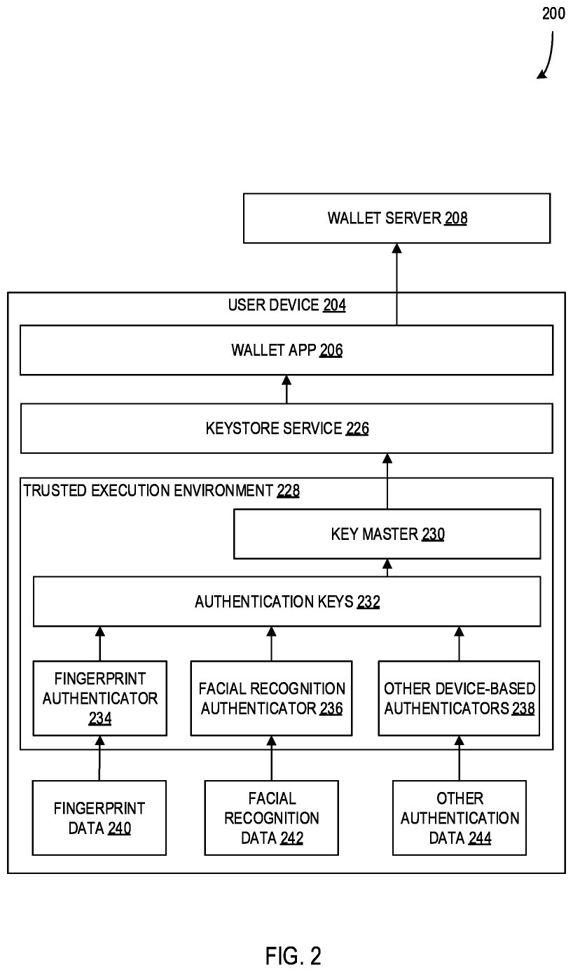

The user device 104 and/or wallet 109 use the authentication server 110 to authenticate the identity of the user 102 when the user uses the user device 104 based on one or more authenticators collected on the device (e.g., device-based user authenticators or authentication data). This identity authentication of the user 102 may be used to enhance the security of the user device 104. For instance, the authentication server 110 may be used to authenticate the user 102 in order to unlock the user device 104 (e.g., using a personal identification number (PIN) or password or facial recognition of the user 102 to unlock a mobile phone). Additionally, such an authentication may be used to authenticate the user 102's identity during a transaction as described herein. In some examples, the authentication server 110 is configured to operate according to an authentication standard, such as the FIDO standard. The authentication process and components within the user device 104 are described in greater detail below with respect to FIG. 2.

The CNP authentication layer 112 includes hardware, firmware, and/or software configured to perform user authentication processes that are trusted to be used in transactions where the card associated with the account to be used (e.g., transactions where a credit card is not available to be used as a credential for authenticating the user). It should be understood that the CNP authentication layer 112 may perform authentication operations and interact with the wallet server 108, the payment network 114, and/or other components or entities as would be understood by a person of ordinary skill in the art without departing from the description herein. In some examples, the CNP authentication layer 112 is configured to perform authentication operations according to established CNP authentication standards, such as the EMV 3DS protocol standard. In many of the examples described herein, the CNP authentication layer 112 and other components of the system are configured to use the 3DS protocol, but it should be understood that, in other examples, other CNP authentication protocols may be used without departing from the description.

The payment network 114 (e.g., MASTERCARD) includes hardware, firmware, and/or software configured to facilitate transactions between a user and a merchant as would be understood by a person of ordinary skill in the art (e.g., facilitating transfer of data between merchant, acquirer, and issuer through authentication, authorization, clearing, and settlement steps). The payment network 114 further includes a DAV service 116 (e.g., a directory service (DS)) that is configured to enable the issuer 124 to approve and delegate authentication of a user based on device-based user authenticators for transactions on accounts of the issuer 124 as described herein. The DAV service 116 includes device authenticator links 118, enrolled account data 120, and issuer-approved authenticator data 122. The device authenticator links 118 link the device-based user authenticators and/or other authentication data to the wallet and/or merchant, the user account, and to an associated issuer approval, such that, for transactions between the user and the wallet using the associated account, the device-based user authenticators are sufficient authentication of the user and the authentication step is delegated to the DAV service 116 by the issuer 124. The enrolled account data 120 includes a list or other data structure of accounts that are enrolled or otherwise enabled to use the DAV service 116 as described herein. The issuer-approved authenticator data 122 includes a list or other data structure of types of authenticators and/or other associated authenticator data that the issuer 124 has approved for use in the authentication of users by the DAV service 116.

It should be understood that “device-based user authenticators” and/or “device-based user authentication data” includes authentication data that is provided to the user device 104 by the user 102 to authentication the user's identity. In some examples, the device-based authentication data includes biometric data captured by the user device 104 and/or PIN or password data provided to the user device 104 by the user 102. The device-based user authentication data may further be multi-use on the user device 104, such that the authentication data is used to authenticate the user's identity for multiple purposes, such as signing on to the device, unlocking the device, and/or for use in electronic payments or transactions as described herein.

In some examples, issuers 124 enroll in the DAV service 116 with the payment network 114 in order to delegate authentication of the users 102 to merchants or wallets (e.g., wallet services provided via the wallet application or app 106 and the wallet server 108), for all or a subset of the issuer 124's account ranges (e.g., the enrolled account data 120).

In some examples, the DAV service 116 enables the issuer 124 to accept the delegation of their authentication through an identity solutions system manager (IS SM) tool. The benefit of this method is the absence of new requirements on the issuer access control server (ACS). Alternatively, or additionally, the issuer 124 may be enabled to delegate user authentication of some or all account ranges dynamically as part of an EMV 3DS call, which may require configuration of the issuer ACS to handle EMV 3DS calls to request delegation of the authentications, and to confirm or reject the delegations.

In some examples, the DAV service 116 is configured to enable issuer 124 to select or unselect the account ranges that are approved for the DAV service, which applies to a pre-defined list of authenticators that are approved by the payment network 114. Additionally, or alternatively, the DAV service 116 enables the issuer 124 to be able to select the categories of authenticators (and modalities if made available by the authenticator) that the issuer 124 approves for use in authentication delegation.

Issuer 124 may update the information at any time using the ISSM tool and/or the EMV 3DS calls described above—however it should be understood that removing account ranges that have been previously registered may have impacts on consumers for which a device authenticator has already been registered.

Merchants and/or wallets (e.g., wallet 109) enroll with the payment network 114 to participate in the DAV service 116, and register authentication solutions (e.g., the authentication server 110) that have been through a certification process defined by the payment network 114. Further, merchants and/or wallet providers enroll through associated acquirers, which are enabled to register them through an ISSM tool or other similar method, as described above with respect to the issuer 124. In some examples, wallet providers are required to contact the payment network 114 to complete enrollment.

Additionally, eligible merchants or wallet providers are enabled to register consumer accounts and/or associated cards and device authenticators through a 3-step process as described herein.

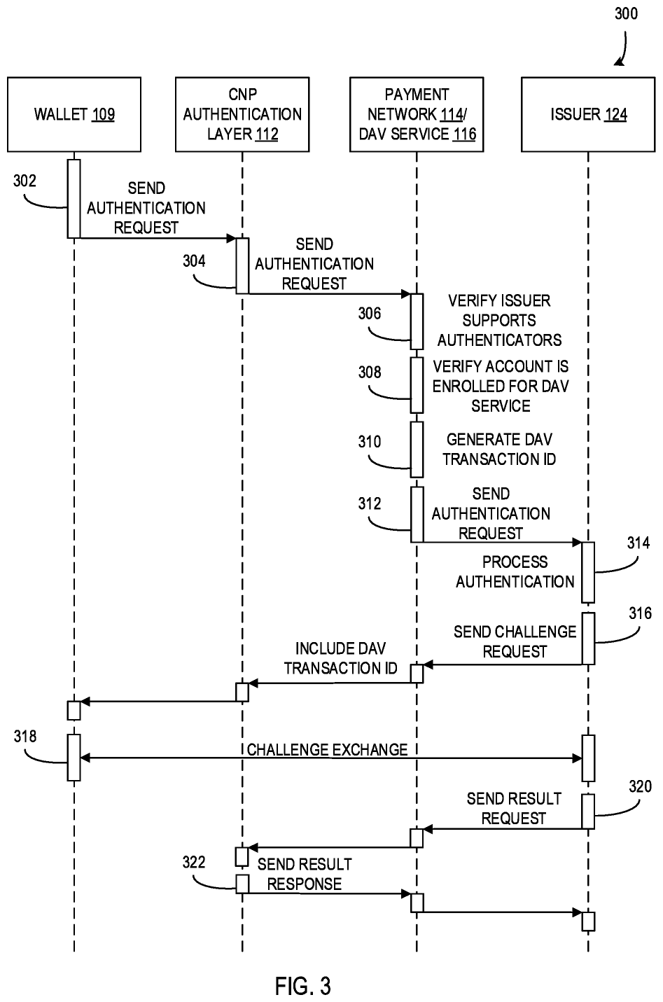

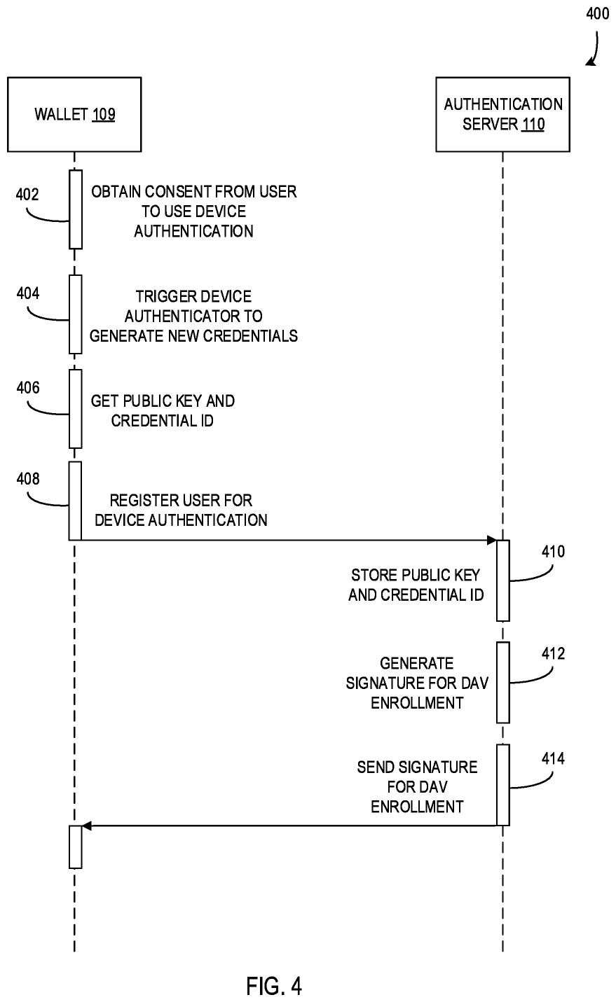

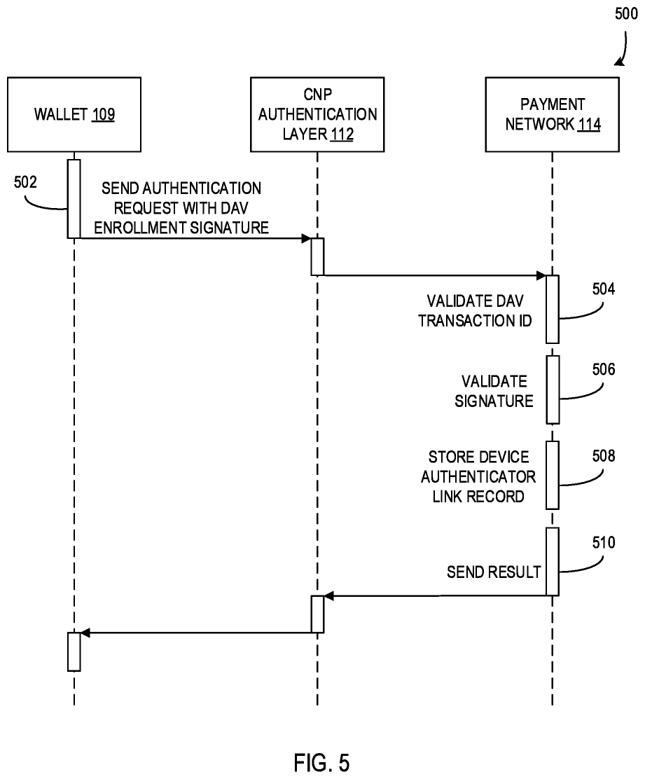

In some examples, the first step is Identification and Verification (ID&V) of the cardholder (e.g., user 102). The identity of the user 102 is validated using an approved mechanism. This step is described in greater detail below with respect to FIG. 3. The second step is enrollment of the user's account with a device authenticator. The merchant or wallet provider obtains consent from the user to use device authentication for an account and/or card using a specific device authenticator. This step can take place before or after step 1 and it is described in greater detail below with respect to FIG. 4. The third step is registration of the user's account and/or card and device authenticator with DAV service. Once the first and second steps above are complete, the merchant or wallet provider registers the account and/or card and the device authenticator with the DAV service. This step is described in greater detail below with respect to FIG. 5. The Issuer 124 ACS is only involved in the first step to step up the user (e.g., challenge the user to provide additional information for authentication)—no change is required on the ACS for the issuer 124 to support the service.

FIG. 2 is a block diagram illustrating a user device 204 configured for enabling device-based authentication via a wallet according to an embodiment. The system 200 includes the user device 204 configured for capturing authentication information from a user using various different types of authenticators 234, 236, and 238 and storing that authentication information in a trusted execution environment 228. In some examples, the user device 204 and wallet server 208 are components in a system such as system 100 of FIG. 1 described above.

The user device 204 includes a keystore service 226 and, in a trusted execution environment 228, a key master component 230 and authentication keys 232 from the fingerprint authenticator 234, the facial recognition authenticator 236, and/or other device-based authenticators 238. In some examples, the authenticators 234, 236, and 238 have internal matching capabilities that can be used to verify the user based on the input fingerprint data 240, facial recognition data 242, and other authentication data 244 respectively. Further, the authenticators of the user device 204 may be configured to generate cryptographic values and/or proofs based on the authentication data collected or received from the user of the device 204. Authenticators may include biometric sensors (e.g., the fingerprint authenticator 234 and facial recognition authenticator 236) and/or PIN or password-based verification. It should be understood that, in other examples, more, fewer, or different authenticators may be included in the user device 204 without departing from the description herein (e.g., voice recognition authenticators). Further, while the authenticators of the user device 204 in FIG. 2 are internal to the device, in other examples, authenticators may also be external to the user device 204 (e.g., connected via universal serial bus (USB) or other interfaces).

The trusted execution environment (TEE) 228 is a secure area of the user device 204 (e.g., a secure area of the processor, memory, and/or other components of the device) that is configured to protect the integrity of the code and/or data processed and stored therein, including the authenticators 234, 236, and 238 and associated authentication keys 232. The key master 230 in the TEE 228 is configured to manage the authentication keys 232 and communicate with the wallet app 206 via the keystore service 226.

FIG. 3 is a sequence diagram illustrating a computerized method 300 for performing identification and verification (ID&V) of a user with respect to an issuer according to an embodiment. At 302, the wallet 109 sends an authentication request to the DAV service 116 via the CNP authentication layer 112 at 304. In some examples, the authentication request is associated with a payment transaction, but alternatively, the authentication request be associated with a non-payment process (e.g., a process focused on authenticating the user of the user device for use in future transactions). Upon receiving the authentication request, the DAV service 116 verifies that the issuer 124 supports the authenticators included in the request (e.g., the types of authentication information, such as PIN/password information, fingerprint information, or facial recognition information) based on the issuer-approved authentication data 122 at 306. At 308, the DAV service 116 further verifies that the account with which the authentication request is associated is enrolled in the DAV service 116 based on the enrolled account data 120. If both verifications are successful, the DAV service 116 generates a DAV transaction ID (e.g., a DS transaction ID as defined in the EMV 3DS protocol) that is unique to the wallet provider or merchant, the account or card number, and the user identity at 310. This DAV transaction ID is stored in a database or other data store associated with the DAV service 116 for use in the other steps described herein. For instance, the DAV transaction ID may be used by the wallet or associated merchant to prove that the ID&V step of FIG. 3 has been performed. The DAV service 116 then sends the authentication request to the issuer 124 at 312.

In some examples, the authentication request is configured for compatibility with a 3MV 3DS protocol and/or authentication process. The EMV 3DS protocol is used to validate the identity of the consumer as described herein. 3DS Servers (e.g., CNP authentication layer 112) have access to the list of accounts and/or cards enrolled into EMV 3DS, enabling them to verify that the Issuer ACS is EMV 3DS-compatible before initiating a request. In this case, the wallet 109 acts as a 3DS requestor and the CNP authentication layer 112 acts as a 3DS server as would be understood by a person of ordinary skill in the art. Alternatively, or additionally, mechanisms other than the EMV 3DS protocol may be used to validate the identity of the consumer.

In some examples, the authentication request from the wallet 109 provides the 3DS server with standard EMV 3DS data required to initiate an EMV 3DS call and, further, the authentication request is configured to request that the 3DS server use 3DS DAV ID&V data (shown in Table 1 below). In further examples, wallet 109 requires a “step up” process using a “3DS Requestor Challenge Indicator” in the authentication request (e.g., by setting the “Challenge Indicator” field to “04”, a step-up challenge process is mandated to complete the authentication).

TABLE 1
Exemplary DAV ID&V data

| Data | | |
|---|---|---|
| Element | Field Name | Description |
| 3DS | threeDSReqAuthData | Length- maximum 2048 bytes |
| Requestor | | JAVASCRIPT Object Notation |
| Authentication | | (JSON) Data Type- string |
| Data | | Value: “Authenticator |
| | | Attestation Globally |
| | | Unique Identifier |
| | | (AAGUID)” (128-bit identifier |
| | | indicating the type |
| | | of the authenticator) |
| 3DS | threeDSReqAuthMethod | Length- 2 characters |
| Requestor | | JSON Data Type- string |
| Authentication | | Value: “90” (value |
| Method | | reserved for payment |
| | | network use) |
| 3DS | threeDSReqAuthTimestamp | Length- 12 characters |
| Requestor | | JSON Data Type- string |
| Authentication | | Value: Timestamp defined |
| Timestamp | | by ISO 8601 |

In the above EMV 3DS-based example, the payment network 114 and/or the DAV service 116 verify that the issuer 124 has an ACS that supports EMV 3DS. If the issuer 124 does not support EMV 3DS, the authentication associated with the request is declined and an error is sent back to the 3DS server. Such errors may be handled in any manner that would be understood by a person of ordinary skill in the art without departing from the description herein. Further, the DAV service 116 validates that the user's account and/or card are eligible for use with the DAV service 116. A value that indicates the status of the eligibility of the account and/or card may be returned to the 3DS server in the authentication response (e.g., an “authentication type” value that is set to either a defined value indicating eligibility or a defined value indicating ineligibility).

The issuer 124 processes the authentication request at 314 and, upon determining that the authentication request is associated with delegating further authentication processing to the DAV service 116 based on device-based authenticators from the user device, the issuer 124 sends an authentication response that includes a challenge request to the wallet 109 (e.g., wallet app 106 and/or wallet server 108) at 316. The challenge request is configured to request additional authentication information from the wallet 109 (e.g., the information may be gathered from the user and/or from the user device upon which the wallet app is installed). At 318, the challenge exchange between the issuer 124 and the wallet 109 may be performed as would be understood by a person of ordinary skill in the art.

In examples using the EMV 3DS protocol, the authentication response from the issuer 124 includes information associated with a 3DS-based challenge flow. In instances where the issuer 124 does not include a request to initiate a challenge exchange with the wallet 109, the lack of the challenge request indicates that the account and/or card are not eligible for use with the DAV service 116. Further, the authentication response may include a value indicating the eligibility status of the account as described above. As the authentication response is processed by the DAV service 116, the generated DAV transaction ID is included in the authentication response, such that the DAV transaction ID is provided to the CNP authentication layer 112 and the wallet 109.

In some examples, when the authentication response including a challenge request is received by the wallet 109, the wallet 109 invokes a 3DS-based challenge flow according to EMV 3DS specifications. Further, if the original authentication request is associated with a payment or other transaction and the authentication response indicates that the account is not eligible for the DAV service 116, the wallet 109 still initiates the challenge exchange to establish authentication for the associated transaction. Alternatively, if the original authentication request was only used to check for eligibility of the account, the challenge exchange may not be initiated.

After the challenge exchange, at 320, the issuer 124 sends a result request to the DAV service 116 and/or payment network 114 generally and the CNP authentication layer 112 to inform those parties that the authentication of the user was successful. The success of this authentication is required for the wallet 109 to proceed to the third step of the registration process (e.g., registration of the user's account and/or card and device authenticator with DAV service). At 322, the CNP authentication layer 112 sends a result response to the result request to confirm receipt of the result request.

Alternatively, or additionally, the DAV service 116 may provide application program interface (API) access to the wallet 109 to enable determination of the eligibility of an account without using an authentication request. Such APIs may also enable access to other information, such as the issuer-approved authentication data 122 indicating types of authenticators that are approved by the issuer 124 and/or current status of device authenticator links 118 associated with a user account.

In some examples, merchants or wallets do not have an API access to a list of account ranges registered for the DAV service 116. In such cases, the merchants or wallets get information indicating whether the account or card is eligible in the step 1 ID&V. Merchants or wallets that do not force a step up for the EMV 3DS authentication request (by using the challenge indicator) may use EMV 3DS without requiring a step up (e.g., so that they do not force a step up for a $5 transaction). Later, if the account or card is found to be eligible for the DAV service 116 and the issuer ACS requires a step up, the challenge flow is initiated. After the user 102 is successfully authenticated, they may proceed to steps 2 and 3 to enroll the account or card in the DAV service 116. Alternatively, if the account or card is found eligible but the issuer ACS has not required a step up, the current flow is finalized, and then another flow is started where a step up is required by using the challenge indicator, after which the process proceeds to steps 2 and 3.

FIG. 4 is a sequence diagram illustrating a computerized method 400 for enrolling a user's account for use with a device-based authenticator according to an embodiment. In some examples, the wallet 109 and authentication server 110 are components of a system such as system 100 of FIG. 1 as described above. The device authenticator may support one or several modalities (e.g. fingerprint recognition, facial recognition etc.). In some examples, the first step for identification and verification of the user as described above with respect to FIG. 3 occurs before this method 400, but in alternative examples, method 400 may occur before method 300 of FIG. 3. The order of these processes may depend on merchant and/or wallet implementation or other associated factors.

At 402, the wallet 109 obtains the consent from the user to use device authentication during online transactions such as checkouts for a specific user account and/or card—the wallet 109 is configured to provide a defined user experience and thus determines when the consent is provided (e.g. when the account is added to the wallet application 106, during checkout, or after checkout).

Once the consent from the consumer is obtained, the wallet 109 connects to the authentication server 110, which is configured to process to the registration of the user with an approved device authenticator. The device authenticator used by the user may include one or several modalities or types of authenticator—the user may register for one or more modalities.

During the registration, at 404, the wallet 109 triggers the device authenticator to create a unique key pair and a unique “credential ID” for that user account and gets the public key and credential ID at 406. At 408, the public key of the key pair and the credential ID are sent to the authentication server 110 to register the user for device authentication. The authentication server 110 stores those values against a unique consumer identifier and the merchant or wallet identifier (the relying party ID) at 410.

In some examples including FIDO-compliant implementations, the public key returned to the authentication server 110 is signed with the attestation private key, and the authentication server 110 validates that the attestation signature over the new public key comes from the correct device. Such implementations may be further configured according to known FIDO specifications without departing from the description herein.

After receiving the registration information, including the public key and credential ID, from the wallet 109, the authentication server 110 generates a signature for use in DAV service enrollment at 412. In some examples, an entity approved by the payment network 114 as a “trusted entity” receives the DAV enrollment data (shown in Table 2 below) from the authentication server 110 and signs it. The trusted entity provides the signed DAV enrollment data and the DAV Enrollment data to the wallet 109 and/or an associated merchant via the authentication server 110 at 414. Exemplary DAV Enrollment Data is shown in Table 2A below.

TABLE 2A
Exemplary DAV Enrollment Data (with use of trusted entity)

| Data | |
|---|---|
| Element | Description |
| Relying Party ID | Value specific to the merchant or wallet |
| (rpID or AppID) | (and unique for all users of that merchant |
| | or wallet). rpID is used in FIDO2, |
| | AppID is used in FIDO UAF |
| Authenticator Attestation | 128-bit identifier indicating the |
| Globally Unique Identifier | type of the authenticator - |
| (AAGUID) or AAID | AAGUID is used in FIDO2, |
| | AAID is used in FIDO UAF |
| Public Key | Minimum size is 16 bytes, |
| | maximum size is 1 KB. |
| Timestamp | Timestamp defined by ISO 8601 |

In some examples, the process for the trusted entity to generate a key pair and get a public key certificate is as follows: The trusted entity approved by the payment network 114 generates a Certificate Signing Request (CSR) and contacts either ENTRUST or DIGICERT or a similar entity to obtain a public key certificate. The contacted entity validates that the trusted entity is a legitimate entity. The trusted entity separately registers with the payment network 114 and shares their complete Distinguished Name (DN) which is included in the certificate.

In alternative examples, the authentication server 110 provides all the registration information from the device to the wallet 109, such that a trusted entity is not used as described above. That would imply however that the DAV service 116 and/or payment network generally stores the registration information (which may be unacceptable based on the regulations or policies that are in place). However, if such an arrangement is acceptable, the described system may benefit from the removal of the trusted entity through increased simplicity and/or efficiency when performing the processes described herein. In such arrangements, the DAV enrollment data may further include registration assertion data that is configured to enable validation of the authentication data that may otherwise be performed by a trusted entity. Exemplary DAV Enrollment Data including the registration assertion data is shown in Table 2B below.

TABLE 2B
Exemplary DAV Enrollment Data (without use of trusted entity)

| Data | |
|---|---|
| Element | Description |
| Relying Party ID | Value specific to the merchant or wallet |
| (rpID or AppID) | (and unique for all users of that merchant |
| | or wallet). rpID is used in FIDO2, |
| | AppID is used in FIDO UAF |
| Authenticator Attestation | 128-bit identifier indicating the |
| Globally Unique Identifier | type of the authenticator - |
| (AAGUID) or AAID | AAGUID is used in FIDO2, |
| | AAID is used in FIDO UAF |
| Public Key | Minimum size is 16 bytes, |
| | maximum size is 1 KB. |
| Registration | e.g., an attestation private key associated |
| Assertion | with the public key enabling validation |
| Data | by the payment network |
| Timestamp | Timestamp defined by ISO 8601 |

FIG. 5 is a sequence diagram illustrating a computerized method 500 for registering a user's account and associated device-based authenticator with a DAV service according to an embodiment. In some examples, the wallet 109, CNP authentication layer 112, and payment network 114 of the method 500 are components in a system such as system 100 of FIG. 1 described above. It should be understood that the registration of the account and device authenticator with the DAV service 116 via the method 500 requires the successful completion of the first step as described above with respect to FIG. 3 and the second step as described above with respect to FIG. 4.

In some examples, the method for a merchant or wallet (e.g., wallet 109) to register a user account and device authentication with the DAV service 116 is to use an EMV 3DS Requestor Initiated (3RI) channel (e.g., the wallet 109 operates as a 3DS Requestor). This EMV 3DS call is only between the 3DS server (e.g., the CNP authentication layer 112) and the payment network 114. It does not reach the issuer ACS or the issuer 124 generally. For the registration to be valid, the wallet 109 must perform this call within 24 hours of the validation of consumer identity (which took place in the first step as described above with respect to FIG. 3). In other examples, other time limits may be used without departing from the description herein (e.g., 48 hours, 12 hours, 6 hours).

When the identity of the user was validated in the first step as described herein, the wallet 109 received a DAV transaction ID associated with that validation. This DAV transaction ID is used during the registration process with the DAV service 116. This ID enables the DAV service to confirm that the user's identity has been validated and that it has been validated within the required time limit. The wallet 109 initiates an authentication request that includes the DAV enrollment signature data and the DAV enrollment data from the second step and the DAV transaction ID from the first step. The authentication request is sent to the payment network 114 via the CNP authentication layer 112 at 502. In some examples, the authentication request is configured as a 3RI non-payment flow using EMV 3DS authentication protocol. An example definition of 3DS DAV Enrollment data is shown below in Table 3.

TABLE 3
Exemplary 3DS DAV Enrollment Data

| Data | | |
|---|---|---|
| Element | Field Name | Description |
| 3DS | threeDSReqPriorAuthData | Length- maximum 20K bytes |
| Requestor Prior | | JSON Data Type- string Value: |
| Transaction | | [signed DAV Enrollment data, |
| Authentication | | DAV Enrollment data, Trusted |
| Data | | entity Public Key certificate]. |
| 3DS | threeDSReqPriorAuthMethod | Length- 2 characters |
| Requestor Prior | | JSON Data Type- string |
| Transaction | | Value: “91” (value |
| Authentication | | reserved for payment |
| Method | | network use) |
| 3DS | threeDSReqAuthTimestamp | Length- 12 characters |
| Requestor Prior | | JSON Data Type- string |
| Transaction | | Value: defined by ISO |
| Authentication | | 8601 |
| Timestamp | | |
| 3DS | threeDSReqPriorRef | Length- 36 characters |
| Requestor Prior | | Value: “DAV Transaction ID” |
| Transaction | | |
| Reference | | |

When the payment network 114 receives the authentication request sent from the wallet 109 via the CNP authentication layer 112, the payment network validates the DAV Transaction ID at 504. This includes verifying that the DAV transaction ID of the authentication request matches an ID that is in the datastore of the DAV service 116 (e.g., an ID stored by the DAV service 116 after the first step described above). Further, the DAV service 116 verifies that the DAV transaction ID is still valid (e.g., verifying that it was generated less than 24 hours ago). If this validation fails, an error is returned to the CNP authentication layer 112 in the authentication response (e.g., an authentication response including an authentication type element that is set to a value indicating that the DAV transaction ID validation failed).

Additionally, at 506, the payment network 114 validates the signature data of the authentication request and, if that validation fails, an error indicating the failure of the signature validation is sent in the authentication response to the CNP authentication layer 112.

If both the DAV transaction ID and the signature of the authentication request are validated, a device authenticator link record, or link, is stored in the device authenticator links 118 of the DAV service 116 at 508. The link includes account data, such as an account identifier and/or data necessary to make a payment from the account, a credential ID associated with the authenticator of the link, an AAGUID, and a relying party ID associated with the wallet 109 and/or the associated wallet provider. More and/or different information may also be included with the link without departing from the description herein.

Upon the link being successfully recorded by the DAV service 116, a success indicator is returned to the wallet 109 via the CNP authentication layer 112 at 510. Based on the recorded link, the user is enabled to initiate transactions from the associated account via the associated wallet such that authentication of the user's identity is done via device-based authenticators without further authentication being performed by the issuer of the account.

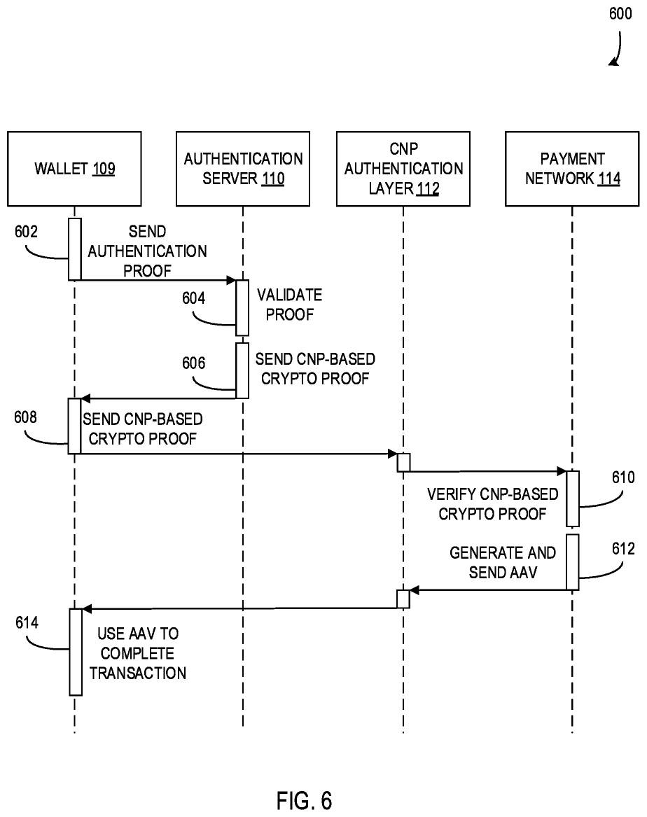

FIG. 6 is a sequence diagram that illustrates a computerized method 600 for preparing a cryptographic proof from the device-based authentication data and for submitting the cryptographic proof to the payment network for authentication during a transaction according to an embodiment. In some examples, the wallet 109, authentication server 110, CNP authentication layer 112, and payment network 114 are components in a system such as system 100 of FIG. 1 as described above. Further, it should be understood that, in some examples, the CNP authentication layer 112 and other components are configured to operate based on the EMV 3DS protocol, such that the CNP authentication layer 112 includes a 3DS server. Additionally, it should be understood that the issuer 124 is not involved in the method 600, as it has delegated the authentication process to the payment network 114 as described above with respect to methods of FIGS. 3, 4, and 5.

During an online transaction, prior to the illustrated steps of method 600 the wallet 109 authenticates the user with device-based authentication. The authentication server 110 sends a challenge to the device authenticator of the wallet 109 registered during enrollment, and consumer authentication is performed.

If the authentication is validated successfully by the device authenticator of the wallet 109, an authentication proof (e.g., an on-device cryptographic proof and/or an “authentication assertion” as described by the FIDO standard) is generated as the result of the device authentication, using a private key stored in the user verification processing environment. At 602, the authentication proof is then sent from the wallet 109 to the authentication server 110. In some examples, the user is prompted to authenticate at the time of transaction—providing additional security at time of payment, and/or meeting regulatory requirements (e.g., the Revised Payment Services Directive (PSD2)). Alternatively, in other examples, the user is prompted to authenticate earlier than the time of the transaction and the wallet 109 leverages that prior authentication that took place a short time earlier (e.g., 5 minutes earlier) and that is considered valid. Therefore, there are two categories of authentication. Instant authentication is when authentication is required at the time of every transaction (typical in regulated markets like PSD2). Prolonged authentication is when authentication is not required at the time of transaction if the user has authenticated in a maximum period of 10 minutes prior to the final confirmation in the checkout process. In other examples, other maximum time periods may also be used without departing from the description. In the case of prolonged authentication, the authentication may have occurred outside of the transaction process or checkout process (e.g. during authentication to unlock a mobile device), provided that the same device authenticator is used and that authentication was performed within the maximum time period. Note that prolonged authentication is not allowed by some regulators (e.g., in PSD2 countries), as they require the consumer to authenticate at the time of transaction, such as when the user confirms the final amount at a specific merchant (“you sign what you see”). In some examples, the wallet 109 contacts the payment network 114 to determine in which markets prolonged authentication is allowed such that authentication processes may be performed in a manner that complies with the regulations of the user's location.

At 604, the authentication server 110 validates the authentication proof generated by the device and is configured to immediately inform the wallet 109 of a failure in user authentication. However, for the authentication to be approved by the payment network 114, the wallet 109 must send a CNP-based cryptographic proof (e.g., a 3DS cryptographic proof) that has been generated from the authentication proof by an entity approved by the payment network 114 as a “trusted entity”. In the illustrated example, the authentication server 110 is a trusted entity with respect to the payment network 114 and is configured to send a CNP-based cryptographic proof back to the wallet 109 at 606. Alternatively, in examples that do not include a separate “trusted entity”, the authentication proof generated by the device is used as the CNP-based cryptographic proof.

In some examples, the CNP-based cryptographic proof is a signature over the DAV transaction data, which is accessible from the authentication proof generated and sent by the user's device via the wallet 109. An example of the DAV transaction data to be signed by a trusted entity is shown below in Table 4A. With respect to examples that do not include a separate “trusted entity”, an example of the DAV transaction data is shown below in Table 4B.

TABLE 4A
Exemplary DAV Transaction Data to be signed by Trusted Entities

| Data | |
|---|---|
| Element | Description |
| Relying Party ID | Value specific to the merchant or wallet |
| (rpID or AppID) | (and unique for all users of that merchant |
| | or wallet). rpID is used in FIDO2, |
| | AppID is used in FIDO UAF |
| AAGUID or AAID | 128-bit identifier indicating the type |
| | of the authenticator - AAGUID is used in FIDO2, |
| | AAID is used in FIDO UAF |
| Public Key | Minimum size is 16 bytes, maximum size is 1 KB. |
| Timestamp | Timestamp defined by ISO 8601 |

TABLE 4B
Exemplary DAV Transaction Data to be signed

| Data | |
|---|---|
| Element | Description |
| Relying Party ID | Value specific to the merchant or wallet |
| (rpID or AppID) | (and unique for all users of that merchant |
| | or wallet). rpID is used in FIDO2, |
| | AppID is used in FIDO UAF |
| AAGUID or AAID | 128-bit identifier indicating the type |
| | of the authenticator - AAGUID is used in FIDO2, |
| | AAID is used in FIDO UAF |
| Public Key | Minimum size is 16 bytes, maximum size is 1 KB. |
| Registration | e.g., an attestation private key associated with |
| Assertion | the public key enabling validation |
| Data | by the payment network |
| Timestamp | Timestamp defined by ISO 8601 |

At 608, the wallet 109 initiates an authentication request to the payment network 114 by sending the authentication request via the CNP authentication layer 112 (e.g., an EMV 3DS call), including the CNP-based cryptographic proof (e.g., a 3DS cryptographic proof). At 610, the payment network 114, via the DAV service 116, verifies the CNP-based cryptographic proof and matches the DAV transaction data retrieved from the CNP-based cryptographic proof with the information stored and approved by the issuer during initial enrollment (e.g., the device authenticator links 118). In examples where the EMV 3DS protocol is used, the wallet 109 initiates a 3DS call that requests the 3DS server to use the 3DS DAV transaction data, including the 3DS cryptographic proof received from the trusted entity and the DAV transaction data as shown in Table 5 below.

TABLE 5
Exemplary 3DS DAV Transaction Data

| Data | Field | |
|---|---|---|
| Element | Name | Description |
| 3DS | threeDSReqAuthData | Length- maximum 20K bytes |
| Requestor | | JSON Data Type- string |
| Authentication | | Value: [3DS cryptographic |
| Data | | proof, DAV Transaction |
| | | data, Trusted entity |
| | | Public Key certificate] |
| 3DS | threeDSReqAuthMethod | Length- 2 characters |
| Requestor | | JSON Data Type- string |
| Authentication | | Value: “92” (value |
| Method | | reserved for payment |
| | | network use) |
| 3DS | threeDSReqAuthTimestamp | Length- 12 characters |
| Requestor | | JSON Data Type- string |
| Authentication | | Value: defined by ISO 8601 |
| Timestamp | | |

If the CNP-based crypto proof is verified by the payment network 114, at 612, an authentication value (e.g., an Accountholder Authentication Value (AAV)) is generated and sent back to the wallet 109 and/or an associated merchant in response to the authentication request. Alternatively, if the validation of the CNP-based crypto proof fails or if the matching of the DAV transaction data to the device authenticator links fails, the payment network 114 sends an “invalid transaction” back to the wallet 109.

Upon receiving the AAV, at 614, the wallet 109 proceeds to complete the transaction using the AAV as proof of authentication of the user's identity. The transaction may be completed in any manner that would be understood by a person of ordinary skill in the art without departing from the description herein (e.g., via interactions with acquirers, merchants, the payment network 114, issuers, etc. to complete the electronic transaction).

In some examples, the AAV is used during the authorization process of the transaction. For instance, merchants or payment service providers (PSPs) may receive the AAV and a DAV transaction ID from the CNP-based authentication layer 112, from an associated PSP, and/or from a 3^{rd} party wallet. Through associated acquirers, the merchants or PSPs may submit an authorization request including the fields shown below in Table 6.

TABLE 6
Exemplary Submission of Authorization Request

| Field | | |
|---|---|---|
| Name | Value | Description |
| Point of Sale | 81 | PAN/Token entry via |
| (POS) | | electronic commerce |
| Entry mode | | |
| Electronic | 212 | Channel, ecommerce/ |
| commerce | | SecureCode, |
| indicators | | UCAF data collection |
| | | is supported by |
| | | the merchant and |
| | | UCAF data must |
| | | be present |
| Universal | AAV with leading | Payment Network 3DS |
| Cardholder | indicator | Secure Payment |
| Authentication | (KK or KD values | Application 2 (SPA2) AAV |
| Field | may be used) | |
| (UCAF) | | |
| Authentication | 2 | Program Protocol = EMV |
| Data | DAV transaction ID | 3DS DAV transaction ID |

In such examples, issuers receive an authorization request including the fields shown below in Table 7.

TABLE 7
Exemplary Submission of Authorization Request

| Field | | |
|---|---|---|
| Name | Value | Description |
| POS | 81 | PAN/Token entry via |
| Entry mode | | electronic commerce |
| Electronic | 212 | Channel, ecommerce/ |
| commerce | | SecureCode, |
| indicators | | UCAF data collection |
| | | is supported by |
| | | the merchant and |
| | | UCAF data must |
| | | be present |
| UCAF | AAV with leading | Payment Network |
| | indicator | 3DS SPA2 AAV. |
| | (KK or KD | Leading indicator |
| | values may be used) | KD or KK indicates |
| | | that device |
| | | authentication was |
| | | validated successfully |
| Digital | Pos 1- 0-9 | Position 1 is risk level |
| Transaction | Pos 2- A-Z | (9 = high risk) |
| Insights | Pos 3- A-Z | Position 2 is reason code |
| | | determined by payment network |
| | | Position 3 is reason code |
| | | determined by the merchant |
| Authentication | 2 DAV | Program Protocol = |
| Data | transaction ID | EMV 3DS DAV |
| | | transaction ID |
| On-behalf (OB) | 05 | AAV verification |
| Services | | service |
| OB Result | Values | V = valid |
| | I, U, or V | |

In such examples, issuers consider the transaction to be fully authenticated with device authentication when an AAV with leading indicator KD or KK is received in the UCAF field and when an on-behalf service 05 with value “V” is received in the OB Services field. Issuers should then approve the transaction as a fully authenticated transaction. Issuers do not attempt to validate the AAV, as they have delegated that validation to the DAV service.

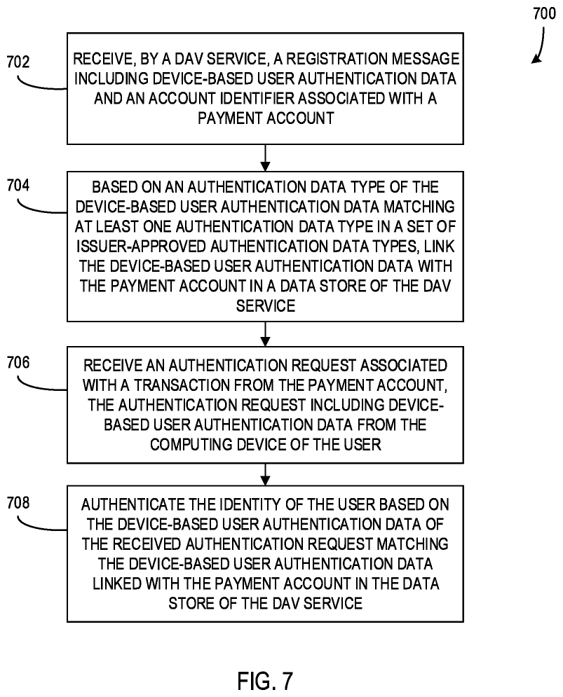

FIG. 7 is a flow chart that illustrates a computerized method 700 for authenticating an identity of a user based on validation of device-based user authentication data and based on linking device-based user authentication data for transactions associated with a payment account according to an embodiment. In some examples, the method 700 is implemented on a system such as system 100 of FIG. 1 by a component or components of the system, such as the DAV service 116. At 702, a DAV service (e.g., the DAV service 116) receives a registration message including device-based user authentication data (e.g., fingerprint data, facial recognition data, password data, or PIN data) and an account identifier associated with a payment account. At 704, based on an authentication data type of the device-based user authentication data matching at least one authentication data type in a set of issuer-approved authentication data types of the issuer associated with the payment account, the DAV service links the device-based user authentication data with the payment account in a data store of the DAV service. In some examples, the method further includes sending an authentication message to the issuer including at least a portion of the received registration message and receiving an authentication response from the issuer based on the authentication message. In such cases, the linking of the device-based authentication data with the payment account is further based on the authentication response indicating the authentication of the user by the issuer. Further, the authentication response may include a challenge result associated with the issuer challenging the user to provide additional authentication data and the linking is further based on that challenge result indicating authentication of the user by the issuer.

Additionally, or alternatively, the registration message includes an enrollment signature indicating the user consented to using the device-based user authentication data with the payment account and linking the authentication data with the payment account is further based on validation of the enrollment signature by the DAV service.

At 706, the payment network that executes the DAV service receives an authentication request associated with a transaction from the payment account, the authentication request including device-based user authentication data from the computing device of the user. At 708, the DAV service authenticates the identity of the user based on the device-based user authentication data of the received authentication request matching the device-based user authentication data linked with the payment account in the data store of the DAV service. In some examples, the authentication request further includes a cryptographic proof generated by an approved entity associated with a wallet application of the user and authenticating the identity of the user based on the authentication request is further based on verification of the cryptographic proof by the DAV service. Further, it should be understood that method 700 may be performed to authenticate the user multiple times for multiple transactions based on receiving multiple authentication requests after the link between the device-based user authentication data and the payment account is formed.

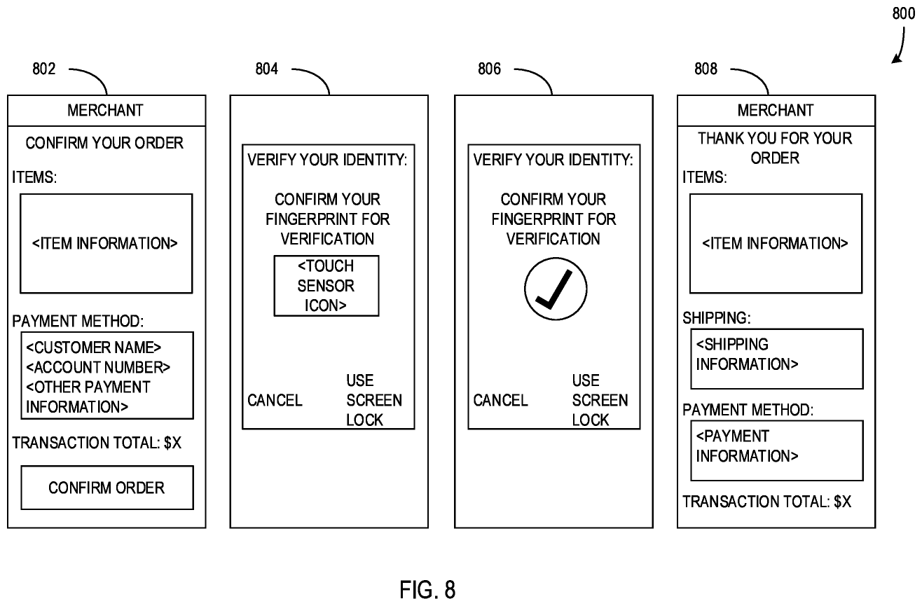

FIG. 8 is a diagram illustrating a graphical user interface (GUI) 800 configured for authentication of an electronic transaction using device-based authentication from a user's point of view according to an embodiment. The GUI 800 includes example user interface screenshots 802-808 illustrating authentication of an electronic transaction from a user's point of view. In the first screenshot 802, the user views a checkout screen on the website of an online store. The user has an item (e.g., a pair of sneakers) in their electronic cart, identified by the item information in the item section. Upon confirming the order of the item, the user is prompted to provide fingerprint biometric data to the device in screenshot 804. Upon providing the fingerprint data, the user's fingerprint is recognized and thereby, the user's identity is confirmed in screenshot 806. The user's fingerprint-based authentication data is used by the merchant of the online store to authenticate the user's identity during the processing of the transaction, such that the transaction is completed in the final screenshot 808.

### Exemplary Operating Environment

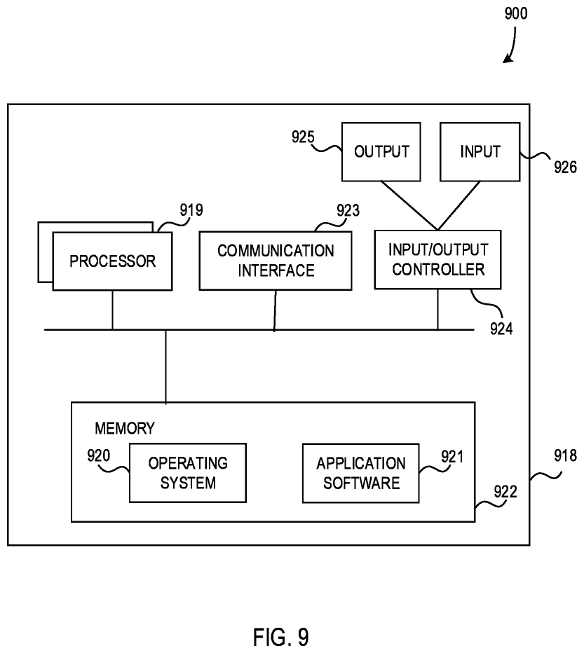

The present disclosure is operable with a computing apparatus according to an embodiment as a functional block diagram 900 in FIG. 9. In an embodiment, components of a computing apparatus 918 may be implemented as a part of an electronic device according to one or more embodiments described in this specification. The computing apparatus 918 comprises one or more processors 919 which may be microprocessors, controllers or any other suitable type of processors for processing computer executable instructions to control the operation of the electronic device. Alternatively, or in addition, the processor 919 is any technology capable of executing logic or instructions, such as a hardcoded machine. Platform software comprising an operating system 920 or any other suitable platform software may be provided on the apparatus 918 to enable application software 921 to be executed on the device. According to an embodiment, authentication of users based on device-based user authentication data during payment transactions as described herein may be accomplished by software, hardware, and/or firmware.

Computer executable instructions may be provided using any computer-readable media that are accessible by the computing apparatus 918. Computer-readable media may include, for example, computer storage media such as a memory 922 and communications media. Computer storage media, such as a memory 922, include volatile and non-volatile, removable and non-removable media implemented in any method or technology for storage of information such as computer readable instructions, data structures, program modules or the like. Computer storage media include, but are not limited to, RAM, ROM, EPROM, EEPROM, persistent memory, phase change memory, flash memory or other memory technology, CD-ROM, digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 922) is shown within the computing apparatus 918, it will be appreciated by a person skilled in the art, that the storage may be distributed or located remotely and accessed via a network or other communication link (e.g. using a communication interface 923).

The computing apparatus 918 may comprise an input/output controller 924 configured to output information to one or more output devices 925, for example a display or a speaker, which may be separate from or integral to the electronic device. The input/output controller 924 may also be configured to receive and process an input from one or more input devices 926, for example, a keyboard, a microphone or a touchpad. In one embodiment, the output device 925 may also act as the input device. An example of such a device may be a touch sensitive display. The input/output controller 924 may also output data to devices other than the output device, e.g. a locally connected printing device. In some embodiments, a user may provide input to the input device(s) 926 and/or receive output from the output device(s) 925.

The functionality described herein can be performed, at least in part, by one or more hardware logic components. According to an embodiment, the computing apparatus 918 is configured by the program code when executed by the processor 919 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system authenticates an identity of a user based on device-based user authentication data for transactions associated with a payment account. The system comprising: at least one processor; and at least one memory comprising computer program code, the at least one memory and the computer program code configured, with the at least one processor, to cause the at least one processor to: receive, by a device authentication validation (DAV) service, a registration message including device-based user authentication data associated with a computing device of the user and an account identifier associated with the payment account; based on an authentication data type of the device-based user authentication data matching at least one authentication data type in a set of issuer-approved authentication data types associated with an issuer of the payment account, link, by the DAV service, the device-based user authentication data with the payment account in a data store of the DAV service; receive, by the DAV service, an authentication request associated with a transaction from the payment account, the authentication request including device-based user authentication data from the computing device of the user; and authenticate, by the DAV service, the identity of the user based on the device-based user authentication data of the received authentication request matching the device-based user authentication data linked with the payment account in the data store of the DAV service, whereby authentication of the identity of the user for the transaction is delegated to the DAV service by the issuer of the payment account based on the linking of the device-based user authentication data with the payment account.

A computerized method authenticates an identity of a user based on device-based user authentication data for transactions associated with a payment account. The method comprising: receiving, by a processor of a device authentication validation (DAV) service, a registration message including device-based user authentication data associated with a computing device of the user and an account identifier associated with the payment account; based on an authentication data type of the device-based user authentication data matching at least one authentication data type in a set of issuer-approved authentication data types associated with an issuer of the payment account, linking, by the processor, the device-based user authentication data with the payment account in a data store of the DAV service; receiving, by the processor, an authentication request associated with a transaction from the payment account, the authentication request including device-based user authentication data from the computing device of the user; and authenticating, by the processor, the identity of the user based on the device-based user authentication data of the received authentication request matching the device-based user authentication data linked with the payment account in the data store of the DAV service, whereby authentication of the identity of the user for the transaction is delegated to the DAV service by the issuer of the payment account based on the linking of the device-based user authentication data with the payment account.

One or more non-transitory computer readable storage media have computer-executable instructions for authenticating an identity of a user based on device-based user authentication data for transactions associated with a payment account. The instructions, upon execution by a processor, cause the processor to at least: receive, by a device authentication validation (DAV) service, a registration message including device-based user authentication data associated with a computing device of the user and an account identifier associated with the payment account; based on an authentication data type of the device-based user authentication data matching at least one authentication data type in a set of issuer-approved authentication data types associated with an issuer of the payment account, link, by the DAV service, the device-based user authentication data with the payment account in a data store of the DAV service; receive, by the DAV service, an authentication request associated with a transaction from the payment account, the authentication request including device-based user authentication data from the computing device of the user; and authenticate, by the DAV service, the identity of the user based on the device-based user authentication data of the received authentication request matching the device-based user authentication data linked with the payment account in the data store of the DAV service, whereby authentication of the identity of the user for the transaction is delegated to the DAV service by the issuer of the payment account based on the linking of the device-based user authentication data with the payment account.

Alternatively, or in addition to the other examples described herein, examples include any combination of the following:
further comprising: sending, by the processor, an authentication message to the issuer, the authentication message including at least a portion of the received registration message; and receiving, by the processor, an authentication response from the issuer based on the authentication message; wherein linking the device-based user authentication data with the payment account in the data store of the DAV service is further based on the authentication response indicating the authentication, by the issuer, of the user.
wherein the authentication response includes a challenge result associated with the issuer challenging the user to provide additional authentication data; and wherein linking the device-based user authentication data with the payment account in the data store of the DAV service is further based on the challenge result indicating the authentication, by the issuer, of the user based on provided additional authentication data.
wherein the registration message includes an enrollment signature indicating the user consented to using the device-based user authentication data with the payment account; and wherein linking the device-based user authentication data with the payment account in the data store of the DAV service is further based on validation of the enrollment signature by the DAV service.
wherein authenticating the identity of the user based on the authentication request is further based on validation of the device-based user authentication data of the received authentication request.
wherein the received authentication request further includes a cryptographic proof generated by an approved entity associated with a wallet application of the user; and wherein authenticating the identity of the user based on the authentication request is further based on verification of the cryptographic proof by the DAV service.
further comprising: receiving, by the processor, additional authentication requests associated with a plurality of transactions from the payment account, the additional authentication requests including device-based user authentication data from the computing device of the user; and authenticating, by the processor, the identity of the user, for each additional authentication request, based on the device-based user authentication data of the received authentication request matching the device-based user authentication data linked with the payment account in the data store of the DAV service.
wherein the device-based user authentication data includes at least one of fingerprint data, facial recognition data, password data, or PIN data.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for receiving, by a processor of a device authentication validation (DAV) service, a registration message including device-based user authentication data associated with a computing device of the user and an account identifier associated with the payment account; based on an authentication data type of the device-based user authentication data matching at least one authentication data type in a set of issuer-approved authentication data types associated with an issuer of the payment account, exemplary means for linking, by the processor, the device-based user authentication data with the payment account in a data store of the DAV service; exemplary means for receiving, by the processor, an authentication request associated with a transaction from the payment account, the authentication request including device-based user authentication data from the computing device of the user; and exemplary means for authenticating, by the processor, the identity of the user based on the device-based user authentication data of the received authentication request matching the device-based user authentication data linked with the payment account in the data store of the DAV service, whereby authentication of the identity of the user for the transaction is delegated to the DAV service by the issuer of the payment account based on the linking of the device-based user authentication data with the payment account.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for authenticating an identity of a user based on device-based user authentication data for transactions associated with a payment account, the system comprising:
at least one processor; and
at least one memory comprising computer program code, the at least one memory and the computer program code configured, with the at least one processor, to cause the at least one processor to:
receive, by a device authentication validation (DAV) service, a registration message including device-based user authentication data associated with a computing device of the user and an account identifier associated with the payment account;
based on an authentication data type of the device-based user authentication data matching at least one authentication data type in a set of issuer-approved authentication data types associated with an issuer of the payment account, link, by the DAV service, the device-based user authentication data with the payment account in a data store of the DAV service;
receive, by the DAV service, an authentication request associated with a transaction from the payment account, the authentication request including device-based user authentication data from the computing device of the user; and
authenticate, by the DAV service, the identity of the user based on the device-based user authentication data of the received authentication request matching the device-based user authentication data linked with the payment account in the data store of the DAV service, whereby authentication of the identity of the user for the transaction is delegated to the DAV service by the issuer of the payment account based on the linking of the device-based user authentication data with the payment account.

2. The system of claim 1, wherein the at least one memory and the computer program code are configured, with the at least one processor, to further cause the at least one processor to:
send, by the DAV service, an authentication message to the issuer, the authentication message including at least a portion of the received registration message; and
receive, by the DAV service, an authentication response from the issuer based on the authentication message; and
wherein linking the device-based user authentication data with the payment account in the data store of the DAV service is further based on the authentication response indicating the authentication, by the issuer, of the user.

3. The system of claim 2, wherein the authentication response includes a challenge result associated with the issuer challenging the user to provide additional authentication data; and
wherein linking the device-based user authentication data with the payment account in the data store of the DAV service is further based on the challenge result indicating the authentication, by the issuer, of the user based on provided additional authentication data.

4. The system of claim 1, wherein the registration message includes an enrollment signature indicating the user consented to using the device-based user authentication data with the payment account; and
wherein linking the device-based user authentication data with the payment account in the data store of the DAV service is further based on validation of the enrollment signature by the DAV service.

5. The system of claim 1, wherein authenticating the identity of the user based on the authentication request is further based on validation of the device-based user authentication data of the received authentication request.

6. The system of claim 1, wherein the received authentication request further includes a cryptographic proof generated by an approved entity associated with a wallet application of the user; and
wherein authenticating the identity of the user based on the authentication request is further based on verification of the cryptographic proof by the DAV service.

7. The system of claim 1, wherein the at least one memory and the computer program code are configured, with the at least one processor, to further cause the at least one processor to:
receive, by the DAV service, additional authentication requests associated with a plurality of transactions from the payment account, the additional authentication requests including device-based user authentication data from the computing device of the user; and
authenticate, by the DAV service, the identity of the user, for each additional authentication request, based on the device-based user authentication data of the received authentication request matching the device-based user authentication data linked with the payment account in the data store of the DAV service.

8. A computerized method for authenticating an identity of a user based on device-based user authentication data for transactions associated with a payment account, the method comprising:
receiving, by a processor of a device authentication validation (DAV) service, a registration message including device-based user authentication data associated with a computing device of the user and an account identifier associated with the payment account;
based on an authentication data type of the device-based user authentication data matching at least one authentication data type in a set of issuer-approved authentication data types associated with an issuer of the payment account, linking, by the processor, the device-based user authentication data with the payment account in a data store of the DAV service;
receiving, by the processor, an authentication request associated with a transaction from the payment account, the authentication request including device-based user authentication data from the computing device of the user; and
authenticating, by the processor, the identity of the user based on the device-based user authentication data of the received authentication request matching the device-based user authentication data linked with the payment account in the data store of the DAV service, whereby authentication of the identity of the user for the transaction is delegated to the DAV service by the issuer of the payment account based on the linking of the device-based user authentication data with the payment account.

9. The computerized method of claim 8, the method further comprising:
sending, by the processor, an authentication message to the issuer, the authentication message including at least a portion of the received registration message; and
receiving, by the processor, an authentication response from the issuer based on the authentication message; and
wherein linking the device-based user authentication data with the payment account in the data store of the DAV service is further based on the authentication response indicating the authentication, by the issuer, of the user.

10. The computerized method of claim 9, wherein the authentication response includes a challenge result associated with the issuer challenging the user to provide additional authentication data; and
wherein linking the device-based user authentication data with the payment account in the data store of the DAV service is further based on the challenge result indicating the authentication, by the issuer, of the user based on provided additional authentication data.

11. The computerized method of claim 8, wherein the registration message includes an enrollment signature indicating the user consented to using the device-based user authentication data with the payment account; and
wherein linking the device-based user authentication data with the payment account in the data store of the DAV service is further based on validation of the enrollment signature by the DAV service.

12. The computerized method of claim 8, wherein the received authentication request further includes a cryptographic proof generated by an approved entity associated with a wallet application of the user; and
wherein authenticating the identity of the user based on the authentication request is further based on verification of the cryptographic proof by the DAV service.

13. The computerized method of claim 8, the method further comprising:
receiving, by the processor, additional authentication requests associated with a plurality of transactions from the payment account, the additional authentication requests including device-based user authentication data from the computing device of the user; and
authenticating, by the processor, the identity of the user, for each additional authentication request, based on the device-based user authentication data of the received authentication request matching the device-based user authentication data linked with the payment account in the data store of the DAV service.

14. The computerized method of claim 8, wherein the device-based user authentication data includes at least one of fingerprint data, facial recognition data, password data, or PIN data.

15. One or more non-transitory computer readable storage media having computer-executable instructions for authenticating an identity of a user based on device-based user authentication data for transactions associated with a payment account that, upon execution by a processor, cause the processor to at least:
receive, by a device authentication validation (DAV) service, a registration message including device-based user authentication data associated with a computing device of the user and an account identifier associated with the payment account;
based on an authentication data type of the device-based user authentication data matching at least one authentication data type in a set of issuer-approved authentication data types associated with an issuer of the payment account, link, by the DAV service, the device-based user authentication data with the payment account in a data store of the DAV service;
receive, by the DAV service, an authentication request associated with a transaction from the payment account, the authentication request including device-based user authentication data from the computing device of the user; and
authenticate, by the DAV service, the identity of the user based on the device-based user authentication data of the received authentication request matching the device-based user authentication data linked with the payment account in the data store of the DAV service, whereby authentication of the identity of the user for the transaction is delegated to the DAV service by the issuer of the payment account based on the linking of the device-based user authentication data with the payment account.

16. The one or more non-transitory computer readable storage media of claim 15, wherein the computer-executable instructions, upon execution by a processor, further cause the processor to at least:
send, by the DAV service, an authentication message to the issuer, the authentication message including at least a portion of the received registration message; and
receive, by the DAV service, an authentication response from the issuer based on the authentication message; and
wherein linking the device-based user authentication data with the payment account in the data store of the DAV service is further based on the authentication response indicating the authentication, by the issuer, of the user.

17. The one or more non-transitory computer readable storage media of claim 16, wherein the authentication response includes a challenge result associated with the issuer challenging the user to provide additional authentication data; and
wherein linking the device-based user authentication data with the payment account in the data store of the DAV service is further based on the challenge result indicating the authentication, by the issuer, of the user based on provided additional authentication data.

18. The one or more non-transitory computer readable storage media of claim 15, wherein the registration message includes an enrollment signature indicating the user consented to using the device-based user authentication data with the payment account; and
wherein linking the device-based user authentication data with the payment account in the data store of the DAV service is further based on validation of the enrollment signature by the DAV service.

19. The one or more non-transitory computer readable storage media of claim 15, wherein the received authentication request further includes a cryptographic proof generated by an approved entity associated with a wallet application of the user; and
wherein authenticating the identity of the user based on the authentication request is further based on verification of the cryptographic proof by the DAV service.

20. The one or more non-transitory computer readable storage media of claim 15, wherein the computer-executable instructions, upon execution by a processor, further cause the processor to at least:
receive, by the DAV service, additional authentication requests associated with a plurality of transactions from the payment account, the additional authentication requests including device-based user authentication data from the computing device of the user; and
authenticate, by the DAV service, the identity of the user, for each additional authentication request, based on the device-based user authentication data of the received authentication request matching the device-based user authentication data linked with the payment account in the data store of the DAV service.
